(19) United States
(12) Patent Application Publication
(10) Pub. No.: US 2025/0342227 A1
(43) Pub. Date: Nov. 6, 2025

(54) INFORMATION PROCESSING DEVICE AND PROGRAM

(71) Applicant: Shin Koike, Miyoshi-shi (JP)

(72) Inventor: Shin Koike, Miyoshi-shi (JP)

(21) Appl. No.: 19/178,148

(22) Filed: Apr. 14, 2025

(30) Foreign Application Priority Data
May 2, 2024 (JP) 2024-074738

(51) Int. Cl. G06F 17/16

(52) U.S. Cl. CPC G06F 17/16

(57) ABSTRACT

Provided is an information processing device including a memory that stores a computer program, and processing circuitry configured to, through execution of the computer program: acquire a plurality of parameters as calculation targets, each parameter having variation in values thereof and having probabilities of the respective values being given as a distribution; generate a plurality of parameter matrices respectively corresponding to the plurality of parameters, the plurality of parameter matrices each having dimensions as many as or less than the number of the parameters, the distribution of each parameter having a width equal to a length of the dimension corresponding to the parameter, each parameter matrix using values into which the distribution of the corresponding parameter is equally divided, as values of elements of the parameter matrix; and subject the elements of the plurality of matrices to calculation to update the elements of the plurality of parameter matrices.

### TECHNICAL FIELD

The present invention relates to an information processing device and a program.

### BACKGROUND ART

Conventionally, calculation using a plurality of parameters in which each of the parameters has variation (distribution) has been known. International Publication No. WO2022/054253 discloses calculation for parameters with distributions.

### SUMMARY OF THE INVENTION

However, when an integral calculation along parameters such as a simulation calculation is performed, there is a correlation between the respective parameters, and the calculation needs to be performed taking the correlation into consideration.

In view of the above circumstances, an object of the present invention is to obtain a result of calculation for a plurality of parameters with distributions, with higher accuracy than conventional calculation.

One aspect of the present invention is an information processing device including:
a memory that stores a computer program; and
processing circuitry, where the computer program, when executed by the processing circuitry, causes the processing circuitry to
acquire a plurality of parameters as calculation targets, each parameter having variation in values thereof and having probabilities of the respective values being given as a distribution,
generate a plurality of parameter matrices respectively corresponding to the plurality of parameters, wherein
   the plurality of parameter matrices each have dimensions as many as or less than the number of the parameters, and the distribution of each parameter has a width equal to a length of the dimension corresponding to the parameter, and
each parameter matrix uses values into which the distribution of the corresponding parameter is equally divided, as values of elements of the parameter matrix, and
subject the elements of the plurality of matrices to calculation to update the elements of the plurality of parameter matrices.

Another aspect of the present invention is a non-transitory computer-readable storage medium storing a program for causing a computer to execute an information processing method including;
acquiring a plurality of parameters as calculation targets, each parameter having variations in a value thereof and having probabilities of the respective values being given as a distribution,
generating a plurality of parameter matrices respectively corresponding to the plurality of parameters, wherein
   the plurality of parameter matrices each have dimensions as many as or less than the number of the parameters, and the distribution of each parameter has a width equal to a length of the dimension corresponding to the parameter, and
   each parameter matrix uses values into which the distribution of the corresponding parameter is equally divided, as values of elements of the parameter matrix, and
subjecting the elements of the plurality of matrices to calculation to update the elements of the plurality of parameter matrices.

According to the information processing device and the program of the present invention, a result of calculation for a plurality of parameters with distributions can be obtained with higher accuracy than conventional calculation.

### BRIEF DESCRIPTION OF THE DRAWINGS

FIG. 1 is a block diagram illustrating a configuration of an information processing device according to the present embodiment;

FIG. 2 illustrates correlations;

FIG. 3 illustrates calculation processing for positions and velocities;

FIG. 4 is a flowchart showing the calculation processing;

FIG. 5A illustrates distributions of parameters;

FIG. 5B illustrates distributions of parameters;

FIG. 5C illustrates distributions of parameters;

FIG. 6 illustrates parameter matrices;

FIG. 7 illustrates a probability matrix;

FIG. 8 illustrates a functional configuration regarding missile control;

FIG. 9A illustrates trajectories of a target and a missile;

FIG. 9B illustrates trajectories of a target and a missile;

FIG. 9C illustrates trajectories of a target and a missile;

FIG. 9D illustrates trajectories of a target and a missile;

FIG. 10A illustrates probability of approach between the target and the missile;

FIG. 10B illustrates probability of approach between the target and the missile;

FIG. 11 illustrates a functional configuration regarding travel control for a vehicle;

FIG. 12A illustrates a first condition;

FIG. 12B illustrates a first condition;

FIG. 13 is a graph showing a trajectory of a vehicle obtained for the first condition;

FIG. 14A illustrates a second condition;

FIG. 14B illustrates a second condition; and

FIG. 15 is a graph showing a trajectory of a vehicle obtained for the second condition.

### DETAILED DESCRIPTION

Hereinafter, an embodiment of the present invention will be described with reference to the drawings.

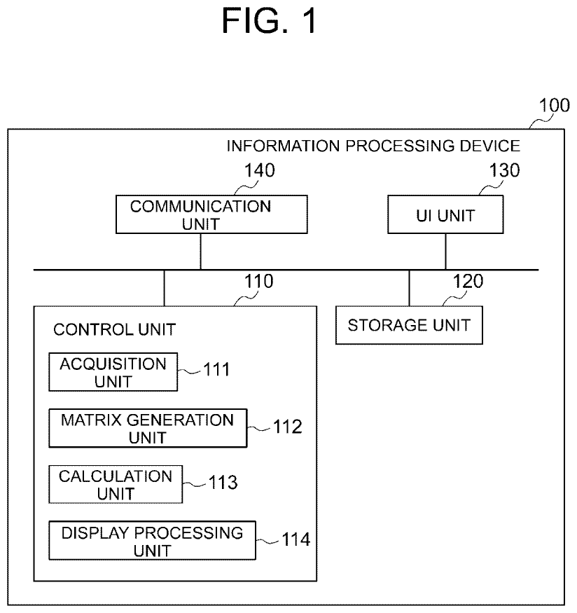

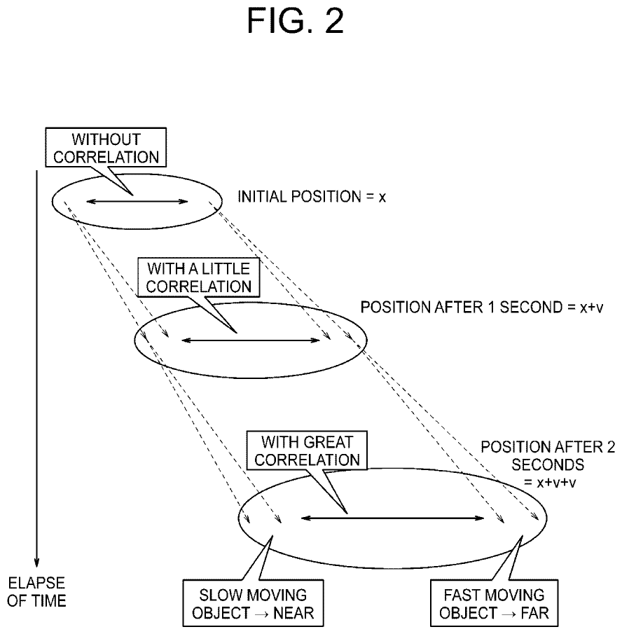

FIG. 1 is a block diagram showing a configuration of an information processing device 100 of the present embodiment. The information processing device 100 performs calculations for a plurality of parameters each having a distribution of values. As shown in FIG. 2, each of the position and the velocity of a moving object may be given as a distribution in which its value varies. In this case, a moving object with a high velocity moves farther away as time elapses. Meanwhile, a moving object with a low velocity stays nearby. This indicates the following. That is, even if the position and the velocity are respectively given independent distributions as initial values, a correlation occurs at the next moment between the position and the velocity, and this correlation becomes stronger as time elapses. Furthermore, when assuming a feedback calculation in which an acceleration is controlled based on a velocity, if the acceleration is assumed to have a distribution, a correlation between these parameters, which changes with time, needs to be considered. The information processing device 100 of the present embodiment performs distribution calculation in consideration of such a correlation that changes with time.

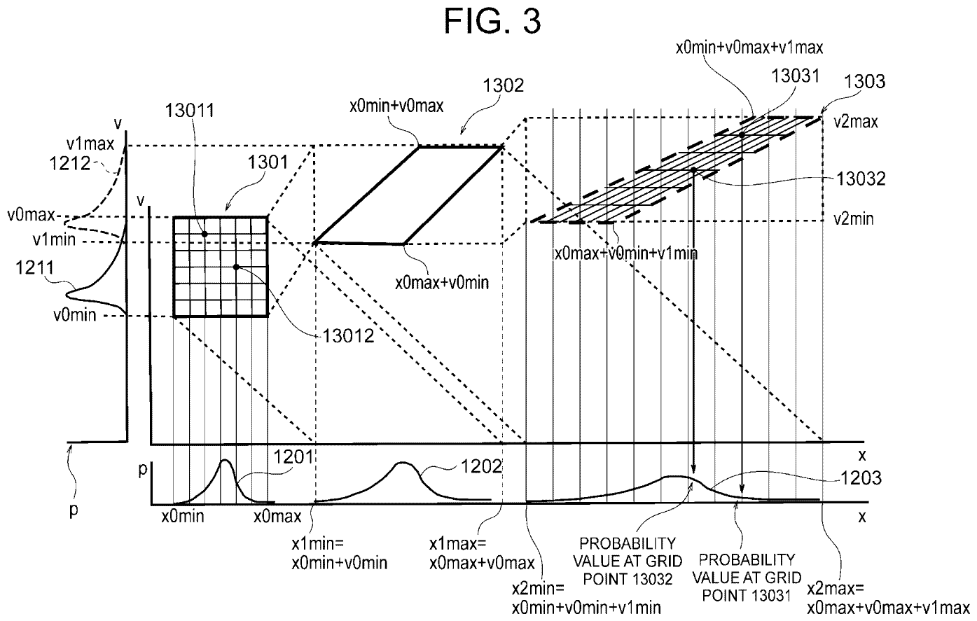

FIG. 3 illustrates calculation processing for positions and velocities. Here, a description will be given of a time-series calculation for obtaining the position of a moving object after movement in a case where the moving object existing in a certain position moves at a certain velocity. It is assumed that the position exhibits variation, i.e., a distribution, in its values. Likewise, the velocity also exhibits variation, i.e., a distribution, in its values.

As shown in an upper-right graph in FIG. 3, a two-dimensional plane with the horizontal axis (axis along the long side of the drawing sheet) representing position x and the vertical axis (axis along the short side of the drawing sheet) representing velocity v, is considered. Each of x and v has a distribution (variation) with respect to the parameter represented on the corresponding axis. A lower-right graph in FIG. 3 is a graph showing the distribution of the position x, in which the horizontal axis (axis along the long side of the drawing sheet) represents the position x and the vertical axis (axis along the short side of the drawing sheet) represents probability p. The graph shows, as the distribution of the position x (position distribution x), a curve 1201 of position distribution x0, a curve 1202 of position distribution x1, and a curve 1203 of position distribution x2. A left graph in FIG. 3 is a graph showing the distribution of the velocity v (velocity distribution v), in which the horizontal axis (axis along the short side of the drawing sheet) represents the velocity v and the vertical axis (axis along the long side of the drawing sheet) represents the probability p. The graph shows, as the distribution of the velocity v (velocity distribution v), a curve 1211 of velocity distribution v0 and a curve 1212 of velocity v1. In the graph, the position x and the velocity v are scaled for calculation purposes.

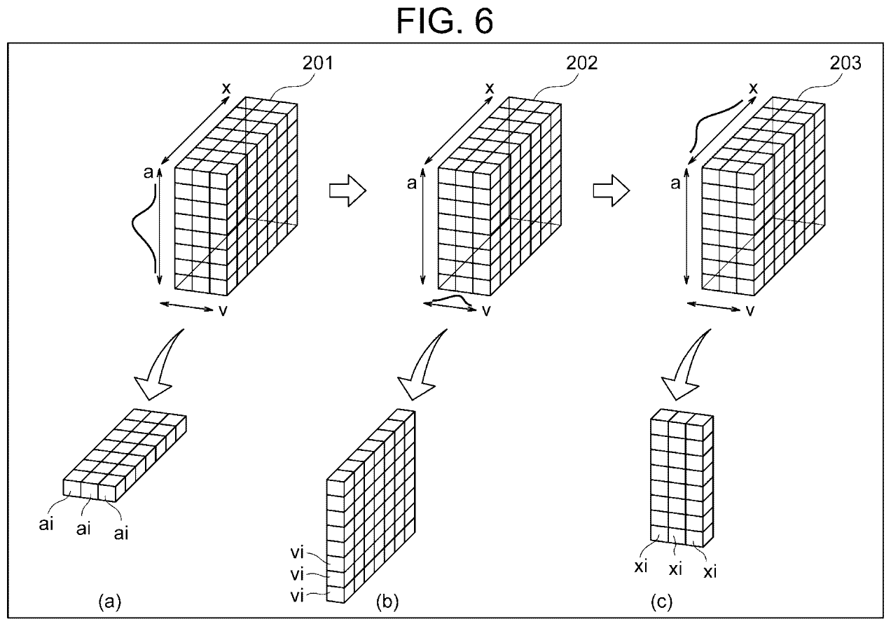

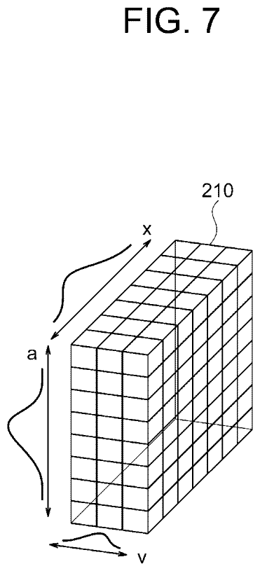

The minimum value and the maximum value of the initial position x0 of the moving object are x0min and x0max, respectively. The minimum value and the maximum value of the initial velocity v0 of the moving object are v0min and v0max, respectively. An initial existence range of the moving object as a calculation target is an initial range 1301 that is a rectangular range shown in FIG. 3, based on the ranges of the initial position distribution x0 and the initial velocity distribution v0. The range 1301 of x and v is divided into grids, and the positions and velocities at points of the grids are the values of parameters to be stored in a matrix (grid points) described later with reference to FIG. 6. Also, probability values of a matrix described later with reference to FIG. 7 correspond to the respective grid points, and a probability value of a product of a probability value of the distribution x0 of the x value and a probability value of the distribution v0 of the v value, at each point, is stored.

Based on calculations for the positions and the velocities at the respective grid points into which the existence range 1301 of the initial position distribution x0 and the initial velocity distribution v0 is divided, an existence range 1302 of the moving object after one second is set. When auxiliary lines (dashed lines) are drawn with an inclination of −1 from upper-right and lower-left vertices of the initial range 1301, the position distribution after one second has a range (value obtained by adding velocity×1 second to position) between two intersections of these auxiliary lines with the x axis (axis of v=0). It is assumed that the velocity changes from v0min to v1min and changes from v0max to v1max according to the distribution. In this case, the position range when the velocity is v1min is represented by (Formula 1) and the position range when the velocity is v1max is represented by (Formula 2).

$$( x 0 min + v 0 min * 1 sec ) ∼ ( x 0 max + v 0 min * 1 sec ) \qquad ( Formula 1 )$$

$$( x 0 min + v 0 max * 1 sec ) ∼ ( x 0 max + v 0 max * 1 sec ) \qquad ( Formula 2 )$$

Therefore, the existence range of the moving object at position x and velocity v after one second is, when expressed in x-v coordinates, a parallelogram-shaped range 1302 surrounded by the following four points.

$$( x 0 min + v 0 min * 1 sec , v 1 min )$$

$$( x 0 max + v 0 min * 1 sec , v 1 min )$$

$$( x 0 min + v 0 max * 1 sec , v 1 max )$$

$$( x 0 max + v 0 max * 1 sec , v 1 max )$$

A parallelogram-shaped range 1303, which is represented by a broken line to the right of the range 1302 in FIG. 3, is the existence range of the moving object after two seconds. After two seconds from when the positions and velocities at the respective points of the grids, into which the range 1301 is divided, were calculated and updated, the positions and velocities are stored at the points of diagonal grids of the range 1303, and form the range. Assuming that the position distribution ranges from x2min to x2max, these values are represented by (Equation 3) and (Equation 4), respectively.

$$x 2 min = x 0 min + v 0 min * 1 sec + v 1 min * 1 sec \qquad ( Equation 3 )$$

$$x 2 max = x 0 max + v 0 max * 1 sec + v 1 max * 1 sec \qquad ( Equation 4 )$$

The existence range of the moving object at position x and velocity v after two seconds is, when expressed in x-v coordinates, the parallelogram-shaped range 1303 surrounded by the following four points.

$$( x 0 min + v 0 min * 1 sec + v 1 min * 1 sec , v 2 min )$$

$$( x 0 max + v 0 min * 1 sec + v 1 min * 1 sec , v 2 min )$$

$$( x 0 min + v 0 max * 1 sec + v 1 max * 1 sec , v 2 max )$$

$$( x 0 max + v 0 max * 1 sec + v 1 max * 1 sec , v 2 max )$$

The interval between x2min and x2max is divided into miniscule intervals by an arbitrary division number, and the probability values at the grid points in the range 1303 which belong to the respective ranges of the divided miniscule intervals are summed up to obtain a probability value of a distribution x2 (1203). For example, a grid point 13031 in the range 1303 in FIG. 3 is the position of a grid point 13011 in the range 1301 after two seconds, and inherits the probability value at the grid point 13011. A grid point 13032 in the range 1303 is the position of a grid point 13012 in the range 1301 after two seconds, and inherits the probability value at the grid point 13012. The probability values at the grid points included in the respective position ranges into which the interval between x2min and x2max is minutely divided are summed up to provide the curve of the probability value of the distribution x2 (1203).

The range of the velocity and the position is gradually concentrated on the diagonal line as time elapses, like the range 1301, the range 1302, and the range 1303. This simulates that the correlation between the velocity and the position becomes stronger although the velocity and the position are independent data in the initial stage. As described above, a matrix for calculating probability distribution after movement is realized. The configuration of the matrix will be described with reference to FIGS. 6 and 7.

In FIG. 3, the parameter ranges of the velocity and the position, and the probability values of distributions thereof have been described. In FIGS. 6 and 7, a three-dimensional matrix in which acceleration is added to the position and the velocity will be described. The relationship between the velocity and the position in FIG. 3 changes similarly to the relationship between the acceleration and the velocity, and the parameters and the probability values at the respective grid points are given as values of the matrix.

As shown in FIG. 1, the information processing device 100 includes a control unit 110, a storage unit 120, a UI unit 130, and a communication unit 140. The control unit 110 includes a CPU, a ROM, a RAM, and the like (not shown), and controls the components of the information processing device 100 with the CPU executing various programs stored in the ROM or the like by using the RAM or the like. The control unit 110 may be formed by a single chip or a plurality of chips. In the control unit 110, an ASIC may be adopted instead of the CPU. Furthermore, in the control unit 110, the CPU and other processing circuits such as an ASIC and a GPU may operate in cooperation.

The storage unit 120 is, for example, a hard disk, and stores various types of information and various programs. The communication unit 140 includes a communication interface circuit for communicating with other devices connected with the information processing device 100 in a wired or wireless manner, according to various communication protocols. The UI unit 130 includes a display unit such as a touch-panel type display, and input devices such as various keys, switches, and a mouse.

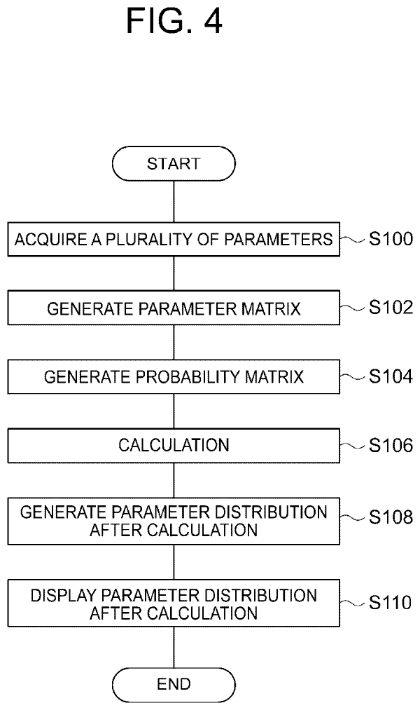

The control unit 110 performs calculation for two or more input parameters. Specifically, the control unit 110 executes a calculation program stored in the ROM or the like to function as an acquisition unit 111, a matrix generation unit 112, a calculation unit 113, and a display processing unit 114. Hereinafter, processes described to be executed by the acquisition unit 111, the matrix generation unit 112, the calculation unit 113, and the display processing unit 114 are processes to be performed by the control unit 110 executing the calculation program. The processes of the acquisition unit 111, the matrix generation unit 112, the calculation unit 113, and the display processing unit 114 will be described in detail with reference to FIG. 4 and the subsequent figures.

FIG. 4 is a flowchart showing calculation processing performed by the control unit 110. In this processing, calculation for a plurality of parameters with distributions is performed. In the present embodiment, a description will be given of a case where, as the calculation, feedback control calculation is performed to control the acceleration of a vehicle as a control target according to a distance from a vehicle traveling ahead.

In this regard, acceleration a, velocity v, and position x are parameters as calculation targets. These three parameters, acceleration a, velocity v, and position x, each exhibit variation, i.e., a distribution, in its values. The feedback control calculation is a time-series calculation. Assuming that a miniscule time is dt, the velocity v changes by dt×a in the miniscule time, and the position x changes by dt×v in the miniscule time. Furthermore, the acceleration a also changes due to feedback of the velocity v. Such feedback calculation causes the distributions of the parameters such as acceleration a, velocity v, and position x, to change. In the calculation processing, changes in the distributions of the parameters after the feedback control calculation are obtained.

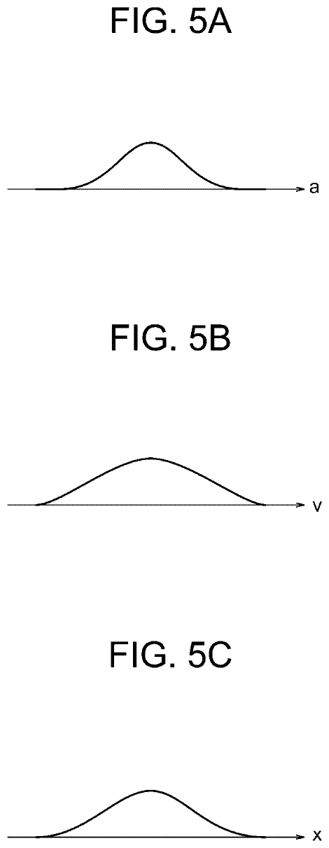

In this processing, firstly, the acquisition unit 111 acquires the distributions of these three parameters as calculation targets (step S100). Here, it is assumed that each parameter exhibits variation (width) in its values, and probabilities of the respective values are given as a distribution. In the present embodiment, the acceleration a has a distribution as shown in FIG. 5(a), the velocity v has a distribution as shown in FIG. 5(b), and the position x has a distribution as shown in FIG. 5(c).

Next, the matrix generation unit 112 generates parameter matrices corresponding to the respective parameters (step S102). In the present embodiment, the matrix generation unit 112 generates three parameter matrices corresponding to the acceleration a, the velocity v, and the position x. FIG. 6 shows the parameter matrices. FIG. 6(a) shows a parameter matrix 201 of the acceleration a. FIG. 6(b) shows a parameter matrix 202 of the velocity v. FIG. 6(c) shows a parameter matrix 203 of the position x.

Any of the parameter matrices 201 to 203 is a matrix having dimensions (axes) corresponding to the number of parameters as calculation targets. That is, in the present embodiment, any of the parameter matrices 201 to 203 has three dimensions of acceleration a, velocity v, and position x. In any of the parameter matrices 201 to 203, the length of the dimension of the acceleration a corresponds to the width of the distribution of the acceleration a, the length of the dimension of the velocity v corresponds to the width of the distribution of the velocity v, and the length of the dimension of the position x corresponds to the width of the distribution of the position x. Each dimension is equally divided, and each of elements formed with widths into which the dimension is divided has a value. In the example shown in FIG. 6, the acceleration a is equally divided into eight parts, the velocity v is equally divided into three parts, and the position x is equally divided into seven parts. In this regard, each of the parameter matrices 201 to 203 is divided into 168 (8×3×7) elements. In actual calculation, each of the parameter matrices 201 to 203 may be divided into more elements.

Each of the elements of the parameter matrix 201 of the acceleration a takes a value of the acceleration a. As shown in FIG. 6(a), 21 (3×7) elements located at the same position in the dimensional direction of the acceleration take the same value (e.g., ai) of the acceleration, while the elements located at different positions in the dimensional direction take different values of the acceleration.

Likewise, each of the elements of the parameter matrix 202 of the velocity v takes a value of the velocity v. As shown in FIG. 6(b), 56 (8×7) elements located at the same position in the dimensional direction of the velocity v take the same value (e.g., vi) of the velocity, while the elements located at different positions in the dimensional direction take different values of the velocity v. Likewise, each of the elements of the parameter matrix 203 of the position takes a value of the position x. As shown in FIG. 6 (c), 24 (8×3) elements located at the same position in the dimensional direction of the position x take the same value (e.g., xi) of the position, and elements located at different positions in the dimensional direction take different values of the position x.

After the process in step S102 shown in FIG. 4, the matrix generation unit 112 generates a probability matrix (step S104). In the present embodiment, the matrix generation unit 112 generates a probability matrix corresponding to the acceleration a, the velocity v, and the position x. FIG. 7 shows the probability matrix. The probability matrix has the same number of dimensions and the same size as each of the three parameter matrices corresponding to the acceleration a, the velocity v, and the position x. That is, the probability matrix has three dimensions corresponding to the acceleration a, the velocity v, and the position x. In addition, each of the dimensions in the probability matrix is also equally divided like the parameter matrices so as to include a plurality of elements. The probability matrix shown in FIG. 7 corresponds to the parameter matrix shown in FIG. 6, and includes 168 elements. Each element takes a value of a product of probability values in the corresponding dimensions.

In the present embodiment, the value of a product of three probability values (probability value of acceleration a, probability value of velocity v, and probability value of position x) is the value of one element. Therefore, the sum of the values of all elements becomes 1. Also, the sum of the values of the elements corresponding to a predetermined acceleration ai (21 elements in the example in FIG. 7) becomes the probability value of the predetermined acceleration ai.

The probability matrix generation process only needs to be performed before the process of generating a parameter distribution after calculation described later, and the processing order is not limited to that of the present embodiment. For example, the probability matrix generation process may be performed after the calculation process (step S106) described later, or before the parameter matrix generation process (step S102).

Next, the calculation unit 113 performs feedback control calculation. In the present embodiment, the calculation unit 113 repeats calculation with a plurality of parameters as calculation targets by the number of times designated in time-series calculation (step S106). For example, in the case of calculation for 100 seconds with the miniscule time dt being 0.01, 10000 (100/0.01) times of repetitive calculation is performed. In the feedback control calculation, the velocity changes depending on the acceleration and the position, and the position changes depending on the acceleration and the velocity. Furthermore, the acceleration changes depending on the velocity and the position. In this feedback control calculation, the values of the elements of the parameter matrix 202 of the velocity v are updated, and the values of the elements of the parameter matrix 203 of the position x are updated. Furthermore, the values of the elements of the parameter matrix 201 of the acceleration a are updated. The values of the elements of the parameter matrices 201 to 203 are updated through the calculation performed as described above.

Through the calculation, value a1 of acceleration is updated to value a2, for example. Thus, the values of the elements of the parameter matrices 201 to 203 are updated. Thus, the elements of the parameter matrices 201 to 203 take different values. For example, although the 21 elements forming the plane shown in FIG. 6(a) each have taken the acceleration ai, the values of these elements are updated to accelerations different from each other. Meanwhile, two different values of acceleration may be updated to the same acceleration through the calculation. In this case, the elements that have taken the two accelerations will take the same acceleration after the calculation.

The calculations for the respective elements by the calculation unit 113 may be executed as parallel processing. This achieves speed-up of the processing. The parallel processing may be achieved by a GPU, for example.

Next, the calculation unit 113 generates distributions after calculation of the respective parameters (step S108). In each parameter matrix after being subjected to the feedback control calculation, the width of each dimension and its minimum value and maximum value may be changed from those before the calculation. Therefore, the calculation unit 113 equally divides the length from the minimum value to the maximum value after the calculation into the same number of parts as that of the dimension before the calculation. For example, regarding the acceleration a, the length from the minimum value to the maximum value after the calculation is equally divided into eight parts.

Then, the calculation unit 113 acquires the values (probability values) of the elements of the probability matrix at the positions corresponding to all the elements updated to the values of the elements obtained through the division. For example, in the case of obtaining the probability value at the third position from the right in the position distribution 1203 after two seconds shown in FIG. 3, the probability values at all the grid points of the position parameter in the range 1303, which are included in the miniscule section of the position parameter may be summed up. One of the grid points is 13031, and this grid point corresponds to the grid point 13011 of the position parameter in the initial range 1301. In terms of the elements of the position matrix, the position distribution corresponds to the second element from the bottom, and the velocity distribution corresponds to the first element from the top. The probability value of the element at the same position in the probability value matrix is used. Likewise, by searching for the probability values included in the miniscule section of the position parameter and summing up the probability values, the probability value at the third position from the right in the position distribution 1203 after two seconds can be obtained. Similarly, the calculation unit 113 obtains the probability values corresponding to the respective elements (acceleration values) from the minimum value to the maximum value of the position parameter after the calculation.

Thereafter, the calculation unit 113 multiplies the summed probability value by the length of each element of the parameter matrix of the position x before the calculation (the length obtained by equally dividing the width of the distribution). Furthermore, the calculation unit 113 divides the value obtained by multiplying the probability value by the length of the element of the parameter matrix, by the equal width of each dimension. Thus, deviations of values caused by different widths of the dimensions due to the calculation can be corrected.

In another example, the calculation unit 113 may correct the summed probability value with a ratio of the equal width of the parameter before the calculation to that after the calculation.

Based on the probability value corresponding to each equal width obtained as described above, the calculation unit 113 generates a parameter distribution of the acceleration a after the calculation. Likewise, the calculation unit 113 generates a parameter distribution of the velocity v after the calculation, and further generates a parameter distribution of the position x after the calculation.

Next, the display processing unit 114 displays the distributions after calculation of the respective parameters on the display unit (step S110). As described above, the information processing device 100 of the present embodiment generates, for each parameter, a parameter matrix having dimensions as many as the number of parameters with distributions, and further generates a probability matrix corresponding to the probabilities of the respective parameters. Then, the information processing device 100 subjects each parameter matrix to calculation and applies the probability matrix to obtain a distribution of each parameter after the calculation. Thus, by performing calculation for the parameter matrix having the dimensions as many as the number of parameters, it is possible to perform the calculation taking into consideration the values corresponding to the distributions of the parameters. Therefore, the result of calculation for the plurality of parameters with distributions can be obtained with higher accuracy than conventional calculation.

Subsequently, an example of calculation for controlling the trajectory of a missile will be described. The control unit 110 controls the trajectory of a missile to perform calculation to shoot down a target. In this control, the missile performs a parabolic motion until the distance between the missile and the target becomes less than a threshold value, and control for the missile trajectory is started when the distance between the missile and the target becomes less than the threshold value. Then, a probability of approach of the missile to the target is calculated. In the present embodiment, it is determined that the missile approaches the target, when the distance between them becomes equal to or less than a reference value (e.g., 20 m). In another example, a probability of contact of the missile with the target may be calculated.

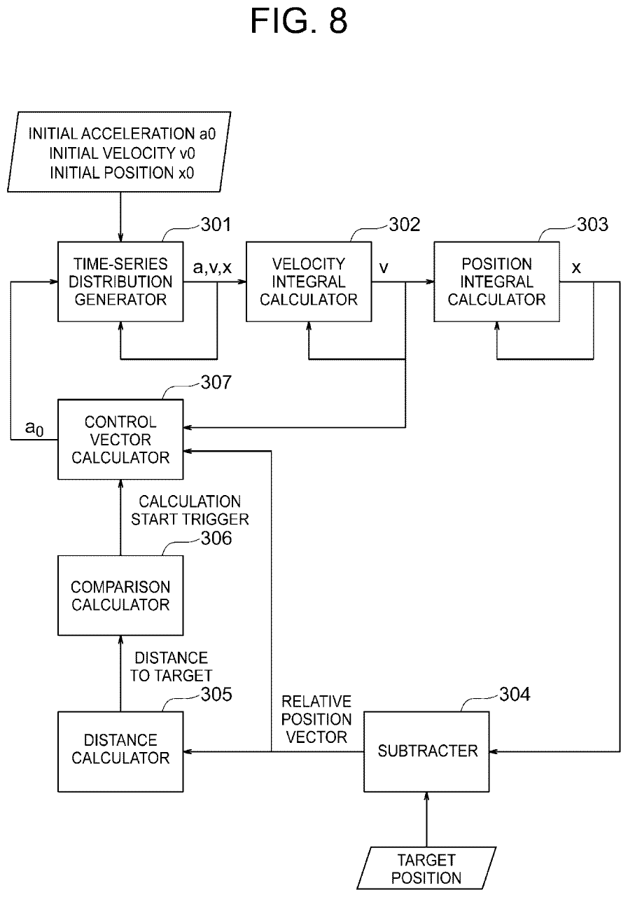

FIG. 8 shows a functional configuration regarding the missile control. The control unit 110 executes a calculation program to function as a time-series distribution generator 301, a velocity integral calculator 302, a position integral calculator 303, a subtractor 304, a distance calculator 305, a comparison calculator 306, and a control vector calculator 307. Hereinafter, processes described to be performed by the time-series distribution generator 301, the velocity integral calculator 302, the position integral calculator 303, the subtractor 304, the distance calculator 305, the comparison calculator 306, and the control vector calculator 307 are processes to be performed by the control unit 110 executing the calculation program.

First, the time-series distribution generator 301 generates, from an initial acceleration a0, an initial velocity v0, and an initial position x0, a parameter matrix of the acceleration a0, a parameter matrix of the velocity v0, and a parameter matrix of the position x0, respectively.

Furthermore, the time-series distribution generator 301 generates a probability parameter matrix. These parameter matrices are inputted to the velocity integral calculator 302. The parameter matrix of the acceleration a0 is updated based on a parameter distribution a0 as control data inputted from the control vector calculator 307 described later, and the parameter matrix of the acceleration a1 after the update is inputted to the velocity integral calculator 302. Likewise, a parameter matrix of the acceleration updated based on a parameter distribution inputted as control data is generated and inputted to the velocity integral calculator 302.

The velocity integral calculator 302 multiplies each of the elements of the parameter matrix of the acceleration a0 by a miniscule interval (dt seconds). Then, the velocity integral calculator 302 adds this value to each of the elements of the parameter matrix of the velocity v0 to generate a parameter matrix of velocity v1 after dt seconds. The parameter matrix of the velocity v1 is inputted to the position integral calculator 303 and the control vector calculator 307. Furthermore, the velocity integral calculator 302 generates a parameter matrix of velocity v2, based on the obtained parameter matrix of the velocity v1 and the parameter matrix of the acceleration a1 after dt seconds. Likewise, using the parameter matrix of the acceleration after dt seconds, a parameter matrix of the velocity after dt seconds is sequentially generated and inputted to the position integral calculator 303 and the control vector calculator 307.

The position integral calculator 303 multiplies each of the elements of the parameter matrix of the velocity v1 by the miniscule interval (dt). Then, the position integral calculator 303 adds this value to the values of the parameter matrix of the position x0 to generate a parameter matrix of position x1 after dt seconds. The parameter matrix of the position x1 is inputted to the subtractor 304. Furthermore, the position integral calculator 303 generates a parameter matrix of position x2, based on the obtained parameter matrix of the position x1 and the parameter matrix of the velocity v2 after dt seconds. Likewise, using the parameter matrix of the velocity after dt seconds, a parameter matrix of the position after dt seconds is sequentially generated and inputted to the subtractor 304.

The position of the target is inputted to the subtractor 304. The subtractor 304 generates a relative position vector, based on the position of the target, and the parameter matrix of position inputted from the position integral calculator 303. Here, the relative position vector is a vector directed from the missile to the target. The relative position vector is inputted to the distance calculator 305 and the control vector calculator 307.

The distance calculator 305 obtains the distance from the missile to the target, and inputs the distance to the comparison calculator 306. When the distance from the missile to the target becomes less than a preset threshold value, the comparison calculator 306 outputs a calculation start trigger to the control vector calculator 307. This simulates that an autonomous sensor detects the position of the target when the missile approaches the target, and the advancing direction of the missile is controlled toward the detected position. Upon receiving the calculation start trigger, the control vector calculator 307 generates a distribution of acceleration a as control data, based on the parameter matrix of the velocity and the relative position vector, and inputs this to the time-series distribution generator 301. The time-series distribution generator 301 updates the parameter matrix of the acceleration, based on the distribution of the acceleration a.

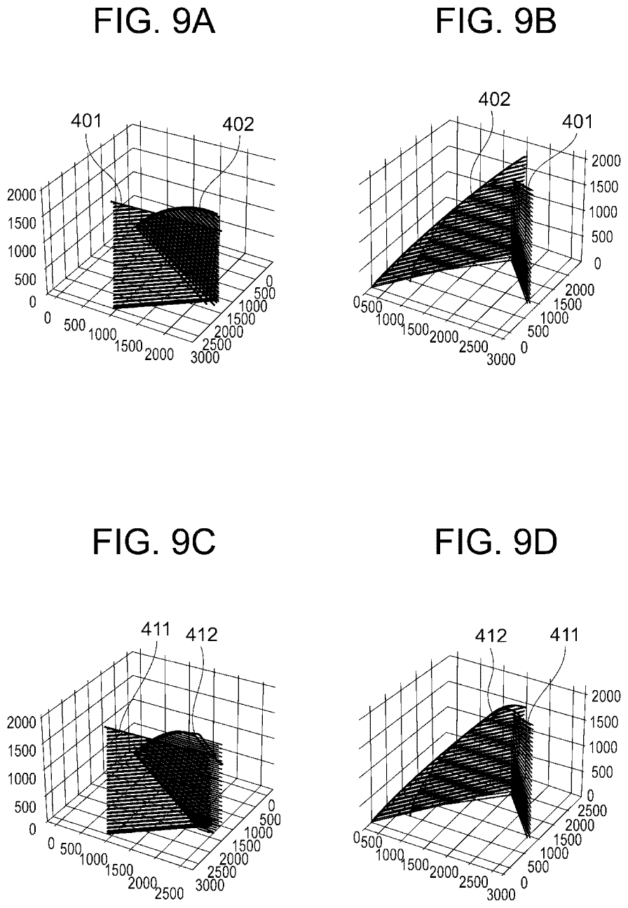

FIGS. 9(a) and 9(b) each show a trajectory 401 of the target and a trajectory 402 of the missile without missile control. FIGS. 9(c) and 9(d) each show a trajectory 411 of the target and a trajectory 412 of the missile with missile control. Each graph has three axes respectively corresponding to x, y, and z directions with a missile launch point as an origin point.

In FIGS. 9(a) and 9(c), the target flies from the left to the right of the drawing sheet, and the missile flies from the back to the right front of the drawing sheet. FIGS. 9(b) and 9(d) are obtained by changing the angles of the graphs of FIGS. 9(a) and 9(c), respectively. In FIGS. 9(b) and 9(d), the target flies from the right front to the back of the drawing sheet and the missile flies from the left to the right back of the drawing sheet.

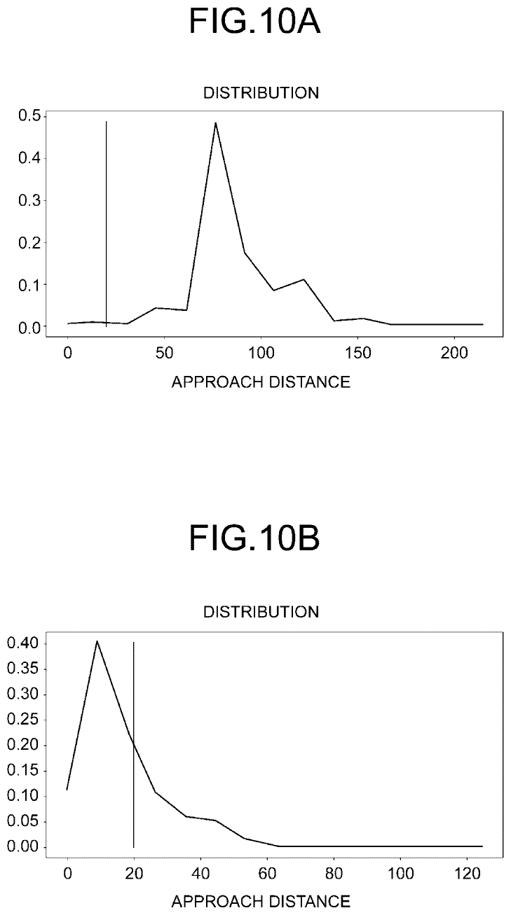

FIG. 10(a) shows an approach probability without missile control. FIG. 10(b) shows an approach probability with missile control. In the graphs of FIGS. 10(a) and 10(b), the horizontal axis represents approach distance, and the vertical axis represents probability. It is determined that the missile approaches the target, when the approach distance becomes less than the threshold value (20 m).

It is found that the probability that the missile approaches the target is 1% when missile control is not performed as shown in FIG. 10(a) while the probability of approach is 70% when missile control is performed as shown in FIG. 10(b). The probability of approach is the sum of the probabilities for the approach distance less than 20 m (an area on the left side of the line of 20 m).

The approach probability is calculated as follows. That is, the control unit 110 obtains approach probabilities, based on the parameter matrices obtained during or after calculation for missile control. Then, the control unit 110 obtains the sum of the probabilities as the sum of approach probabilities.

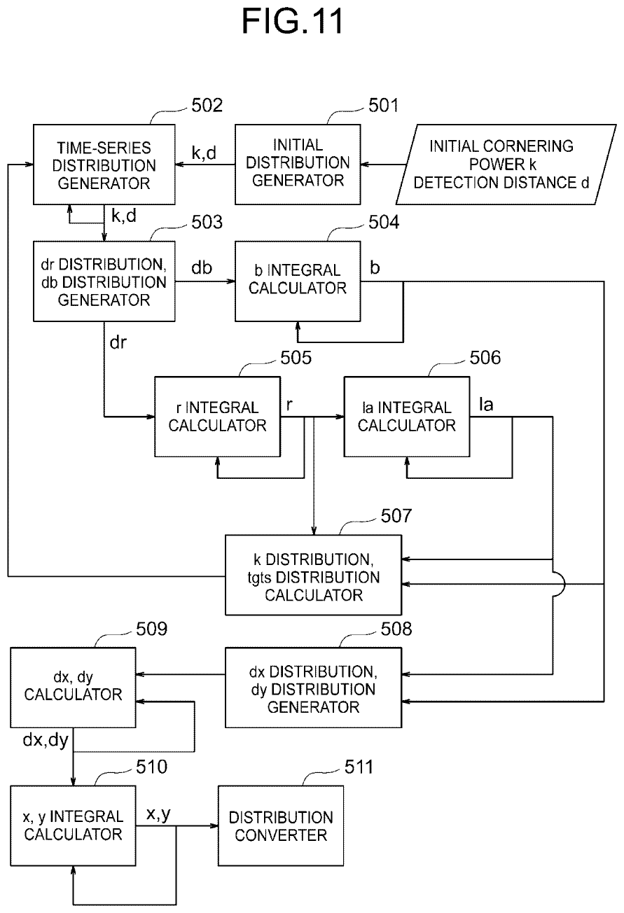

Next, an example of performing calculation for controlling traveling of a vehicle will be described. If there is a stopped vehicle ahead, the control unit 110 performs control calculation for avoiding this vehicle by steering the vehicle to be controlled. It is assumed that the velocity of the vehicle to be controlled is constant. FIG. 11 shows a functional configuration regarding the vehicle traveling control. The control unit 110 executes a calculation program to function as an initial distribution generator 501, a time-series distribution generator 502, a dr distribution, db distribution generator 503, a b integral calculator 504, an r integral calculator 505, an Ia integral calculator 506, a K distribution, tgts distribution calculator 507, a dx distribution, dy distribution generator 508, a dx, dy calculator 509, an x, y integral calculator 510, and a distribution converter 511.

Hereinafter, processes described to be performed by the initial distribution generator 501, the time-series distribution generator 502, the dr distribution, db distribution generator 503, the b integral calculator 504, the r integral calculator 505, the Ia integral calculator 506, the K distribution, tgts distribution calculator 507, the dx distribution, dy distribution generator 508, the dx, dy calculator 509, the x, y integral calculator 510, and the distribution converter 511 are processes to be performed by the control unit 110 executing the calculation program.

In advance of describing the processes, various parameters will be described. The traveling direction of the vehicle is x, and the lateral direction of the vehicle is y. The motion of the vehicle is represented by yaw rate (r), slip angle (b) of the vehicle body, steering angle (s) of tires, and direction (Ia) in which the vehicle body faces. The slip angle is an angle formed between the vehicle traveling direction and the direction in which the vehicle faces. Motion equations are represented by the following (Equation 5) to (Equation 9).

$${r}_{n + 1} = {r}_{n} + dr * dt \qquad ( Equation 5 )$$

$${b}_{n + 1} = {b}_{n} + db * dt \qquad ( Equation 6 )$$

$${Ia}_{n + 1} = {Ia}_{n} + r * dt \qquad ( Equation 7 )$$

$${y}_{n + 1} = {y}_{n} + v * sin ( Ia + b ) * dt \qquad ( Equation 8 )$$

$${x}_{n + 1} = {x}_{n} + v * cos ( Ia + b ) * dt \qquad ( Equation 9 )$$

As shown in FIG. 11, the initial distribution generator 501 generates an initial cornering power K and an initial distribution of detection distance d. The initial distribution is inputted to the time-series distribution generator 502. The time-series distribution generator 502 generates a parameter matrix of the cornering power K (hereinafter referred to as K distribution with Kf=Kr=K), and a parameter matrix of the detection distance d. Furthermore, the time-series distribution generator 502 generates a probability parameter matrix. These parameter matrices are inputted to the dr distribution, db distribution generator 503. The dr distribution, db distribution generator 503 obtains a dr distribution and a db distribution from the parameter matrix of the cornering power K and the parameter matrix of the detection distance d according to an equation of motion represented by the following (Equation 10).

$$( 10 )$$

$$( \begin{matrix}\dot{r} \\ \dot{b}\end{matrix} ) = ( \begin{matrix}\begin{matrix}- ( 2 * Kf * If ** 2 + 2 * Kr * Ir ** 2 ) / \\ ( Iz * v )\end{matrix} & - ( 2 * Kf * If - 2 * Kr * Ir ) / Iz \\ \begin{matrix}- ( 1 + ( 2 * Kf * If - 2 * Kr * Ir ) / \\ ( m * v ** 2 ) )\end{matrix} & - ( 2 * Kf + 2 * Kr ) / ( m * v )\end{matrix} ) ( \begin{matrix}r \\ b\end{matrix} ) + ( \begin{matrix}2 * Kf * If / Iz \\ 2 * Kf / ( m * v )\end{matrix} ) s$$

where Kf is the front cornering power, Kr is the rear cornering power, If is the distance from the position of the center of gravity to the position of front tires, Ir is the distance from the position of the center of gravity to the position of rear tires, m is the mass of the vehicle body, and Iz is the moment of inertia. Here, distributions having independent variations are the two distributions of the cornering power K and the detection distance d, and distributions of the other values are dependent variations obtained through distribution calculations for the two distributions. Therefore, calculation is performed with the dimension of each matrix being two dimensions.

The b integral calculator 504 generates a parameter matrix of b by adding each of the elements of a parameter matrix of db*dt to the previous value of b. The parameter matrix of b is inputted to the K distribution, tgts distribution calculator 507 and the dx distribution, dy distribution generator 508. Furthermore, the b integral calculator 504 updates the parameter matrix of b, based on the obtained parameter matrix of b, and db. Thus, the parameter matrix of b is updated along a time sequence, and the updated parameter matrix is inputted to the K distribution, tgts distribution calculator 507 and the dx distribution, dy distribution generator 508.

The r integral calculator 505 generates a parameter matrix of r by adding each of the elements of a parameter matrix of dr*dt to the previous value of r. The parameter matrix of r is inputted to the Ia integral calculator 506 and the K distribution, tgts distribution calculator 507. Furthermore, the r integral calculator 505 updates the parameter matrix of r, based on the obtained parameter matrix of r, and dr. Thus, the parameter matrix of r is updated along a time sequence, and the updated parameter matrix is inputted to the Ia integral calculator 506 and the K distribution, tgts distribution calculator 507.

The Ia integral calculator 506 generates a parameter matrix of Ia by adding each of the elements of a parameter matrix of r*dt to the previous value of Ia. The parameter matrix of Ia is inputted to the K distribution, tgts distribution calculator 507 and the dx distribution, dy distribution generator 508. Furthermore, the Ia integral calculator 506 updates the parameter matrix of Ia, based on the obtained parameter matrix of Ia and the parameter matrix of r. Thus, the parameter matrix of Ia is updated along a time sequence, and the updated parameter matrix is inputted to the K distribution, tgts distribution calculator 507 and the dx distribution, dy distribution generator 508.

The K distribution, tgts distribution calculator 507 obtains a K distribution and a tgts distribution, based on the parameter matrix of r, the parameter matrix of b, and the parameter matrix of Ia. Here, the tgts distribution is a distribution of a target steering angle of the tires of the vehicle to be controlled. The K distribution and the tgts distribution are inputted to the time-series distribution generator 502. In the time-series distribution generator 502, the parameter matrix of K and the parameter matrix of d are updated based on these distributions.

Furthermore, the dx distribution, dy distribution generator 508 generates a dx distribution and a dy distribution, based on the parameter matrix of Ia and the parameter matrix of b. The dx, dy calculator 509 calculates dx and dy, and dx and dy are inputted to the x, y integral calculator 510. Furthermore, the dx, dy calculator 509 updates the parameter matrix of dx, dy, based on the obtained parameter matrix of dx, dy.

The x, y integral calculator 510 obtains a parameter matrix of x, y by performing integral calculation based on the parameter matrix of dx, dy. The parameter matrix of x, y is inputted to the distribution converter 511. Furthermore, the x, y integral calculator 510 updates the parameter matrix of x, y, based on the obtained parameter matrix of x, y. In the distribution converter 511, conversion from the parameter matrix of x, y to the distribution of x, y is performed.

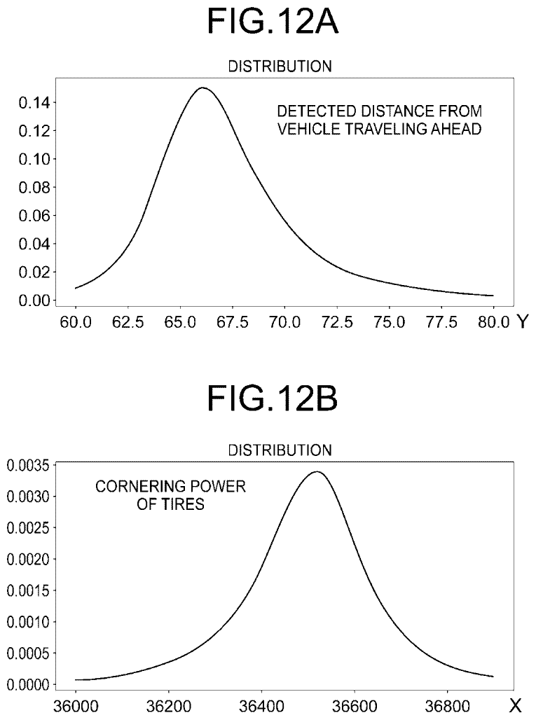

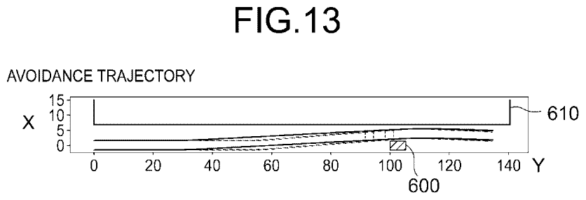

FIG. 12(a) and FIG. 12(b) show a first condition. As shown in FIG. 12(a), in the first condition, the detection distance is a distribution from 60 m to 80 m. The cornering power in this case has a distribution as shown in FIG. 12(b). FIG. 13 is a graph showing the trajectory of the vehicle, obtained for the first condition. A solid line represents the trajectory of the front-side both ends of the vehicle, and a broken line represents the trajectory of the rear-side both ends of the vehicle. Reference numeral 600 denotes a vehicle traveling ahead. It is found from the graph shown in FIG. 13 that the vehicle 600 traveling ahead can be successfully avoided.

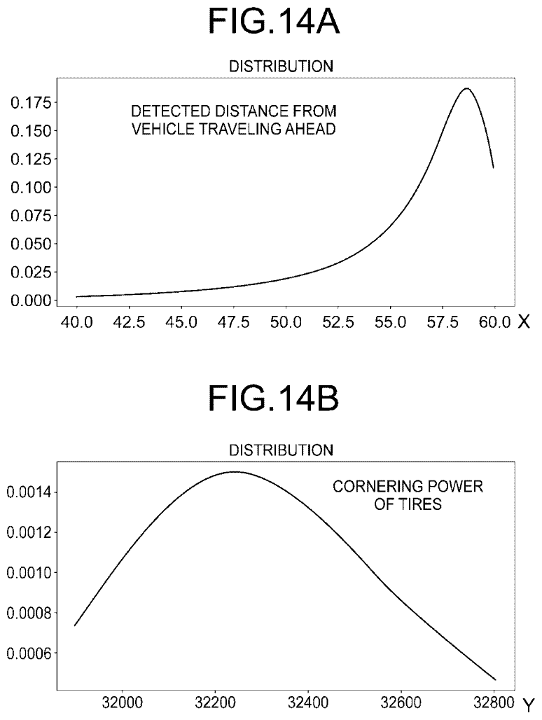

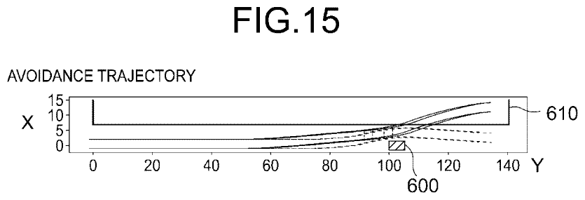

FIG. 14(a) and FIG. 14(b) show a second condition. As shown in FIG. 14(a), in the second condition, the detection distance is a distribution from 40 m to 60 m. FIG. 15 is a graph showing the trajectory of the vehicle, obtained for the second condition. It is found from the graph shown in FIG. 15 that there is a possibility of collision with a neighboring wall 610 although the vehicle 600 traveling ahead can be successfully avoided. In this case, the probability of collision can be accurately calculated.

As described above, the information processing device 100 of the present embodiment can obtain the result of calculation for a plurality of parameters with distributions, with higher accuracy than conventional calculation.

The above embodiment is an example of implementation of the present invention, and various other embodiments can be adopted. Various modifications and changes, such as applying one modification example to another modification example, can be made within the scope of the present disclosure described in the claims. For example, at least some of the components constituting the information processing device 100 may exist separately in a plurality of devices or systems. Furthermore, some of the components of the above embodiment may be omitted, or the order of processing may be changed or the processing may be partially omitted.

In a first modification, the information processing device 100 may not necessarily perform calculation of a distribution using a probability matrix. The information processing device 100 can perform calculation with distributions without omission by performing calculation between a plurality of parameter matrices.

In a second modification, the number of parameters as calculation targets is not limited to that of the present embodiment, and may be two or four or more. In any case, the control unit 110 may generate matrices as many as the number of parameters so that each matrix has dimensions corresponding to the respective parameters, and perform calculation using the parameters.

Although the matrix generation unit 112 generates a parameter matrix having dimensions as many as the number of parameters, the matrix generation unit 112 may generate a parameter matrix having dimensions less than the number of parameters as calculation targets.

A third modification will be described. In the present embodiment, the parameters independent from each other are used as the dimensions of a parameter matrix. However, a dependent parameter may be added to the dimensions of the parameter matrix. For example, in calculation for controlling traveling of a vehicle, in addition to the cornering power K and the detection distance d, a yaw rate r as a parameter depending on the cornering power K may be added to generate a three-dimensional parameter matrix.

Furthermore, the present invention can be implemented as a program or a method. The above-described system, program, and method may be implemented with a single device or may be implemented using common components, and thus include various aspects. For example, it is possible to provide a method or a program implemented by the system as described above. Furthermore, variations can be made as appropriate to implement a configuration partially constituted by software and partially constituted by hardware and the like. The invention is also implementable with a recording medium for a program controlling a device. It is a matter of course that the recording medium of the software may be a magnetic recording medium or a semiconductor memory, and the above concept is directly applicable to any recording medium to be developed in the future.

1. An information processing device comprising:
a memory that stores a computer program; and
processing circuitry, where the computer program, when executed by the processing circuitry, causes the processing circuitry to
acquire a plurality of parameters as calculation targets, each parameter having variation in values thereof and having probabilities of the respective values being given as a distribution,
generate a plurality of parameter matrices respectively corresponding to the plurality of parameters, wherein
the plurality of parameter matrices each have dimensions as many as or less than the number of the parameters, and the distribution of each parameter has a width equal to a length of the dimension corresponding to the parameter, and
each parameter matrix uses values into which the distribution of the corresponding parameter is equally divided, as values of elements of the parameter matrix, and
subject the elements of the plurality of matrices to calculation to update the elements of the plurality of parameter matrices.

2. The information processing device according to claim 1, wherein the computer program further causes the processing circuitry to
generate a probability matrix corresponding to the plurality of parameters, the probability matrix having, as a value of each element, a product of probability values for each of combinations of the plurality of parameters, and
sort the elements of the parameter matrix after the calculation according to the values thereof, sum up probabilities of elements of the probability matrix which are associated with the elements of the parameter matrix before the calculation according to the sorting to obtain probability values for the elements of the parameter matrix after the calculation, and obtain distributions of the plurality of parameters after the calculation, based on the probability values.

3. The information processing device according to claim 2, wherein the computer program further causes the processing circuitry to
multiply the length of each element of the parameter matrix before the calculation by the probability value that is determined by the probability matrix, and
divide a value obtained through the multiplication by a miniscule width obtained by equally dividing the width of the distribution of the parameter after the calculation, to obtain distributions of the plurality of parameters after the calculation.

4. The information processing device according to claim 2, wherein the computer program further causes the processing circuitry to
correct the probability value that is determined by the probability matrix, with a ratio of a length obtained by equally dividing the distribution of the parameter before the calculation to a length obtained by equally dividing the distribution of the parameter after the calculation, to obtain distributions of the plurality of parameters after the calculation.

5. The information processing device according to claim 1, wherein the computer program further causes the processing circuitry to
when one of the parameters has a plurality of dimensions, consolidate the plurality of parameters to a parameter of one dimension.

6. The information processing device according to claim 1, wherein the number less than the number of the parameters is the number of mutually dependent parameters.

7. The information processing device according to claim 1, wherein
the calculation is for obtaining a probability that a control object approaches or contacts an obstacle,
the parameter is a movement trajectory of the control object, and
the computer program further causes the processing circuitry to
based on the parameter matrix obtained during and after the calculation, determine that the control object approaches or contacts the obstacle when the control object is located within a range that is determined based on the position of the obstacle, and
obtain, as a probability of approach or contact, a sum of probability values at which it is determined that the control object approaches or contacts the obstacle during movement of the control object.

8. A non-transitory computer-readable storage medium storing a program for causing a computer to execute an information processing method comprising;
acquiring a plurality of parameters as calculation targets, each parameter having variations in a value thereof and having probabilities of the respective values being given as a distribution,
generating a plurality of parameter matrices respectively corresponding to the plurality of parameters, wherein
the plurality of parameter matrices each have dimensions as many as or less than the number of the parameters, and the distribution of each parameter has a width equal to a length of the dimension corresponding to the parameter, and
each parameter matrix uses values into which the distribution of the corresponding parameter is equally divided, as values of elements of the parameter matrix, and
subjecting the elements of the plurality of matrices to calculation to update the elements of the plurality of parameter matrices.
